(19) United States
(12) Patent Application Publication
(10) Pub. No.: US 2008/0037279 A1
(43) Pub. Date: Feb. 14, 2008

(54) Tapered prism illumination apparatus for LCD backlight

(76) Inventor: Tsung-Wen Chan, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/500,382

(22) Filed: Aug. 8, 2006

(51) Int. Cl. F21V 7/04

(52) U.S. Cl. 362/612

(57) ABSTRACT

A tapered prism illumination apparatus for LCD backlight consists of an LCD, a plurality of LEDs and a heat dissipation base. The plurality of LEDs consists of high power LEDs mounted in the back of the LCD, wherein each of the LEDs includes a light emitting point that is packaged exteriorly with a transparent covering body and, on the light emitting path of the LED, a tapered prism is disposed. In the periphery of the LED a thermally conducting substrate is disposed, while the heat dissipation base is mounted in the rear of the LEDs and has reflecting faces in the periphery of each of the LEDs. When light is generated at the light emitting point, it can be projected onto the tapered prism, by which it is bent by 90°, and then projected onto the LCD via the reflecting faces. The heat generated by the high power LEDs is conducted by the thermally conducting substrate to the heat dissipation base to be removed.

### BACKGROUND OF THE INVENTION

1. Field of the Invention

The present invention relates to a tapered prism illumination apparatus for LCD backlight and, more specifically, to an illumination apparatus for LCD backlight that can be assembled in modules and manufactured and maintained easily, and can present uniform and saturated brightness and color.

2. Description of Related Art

Current illumination apparatuses for LCD (liquid crystal display) backlight are mainly the white-light cold cathode fluorescent lamp (CCFL), which is disposed in the back of an LCD, emitting and projecting light onto the guide-light plate, diffuser and brightness enhancement film and subsequently spotting the light onto the LCD, so that an image may be displayed on the LCD. In view of the increasingly larger size of the LCD, the required CCFL and the driving circuit thereof must have increased sizes as well. In order to attain the backlight illumination function of large size LCDs, it is necessary to connect multiple CCFLs in series/parallel. However, due to several innate causes, the CCFL has the following disadvantages:

1. The CCFL has non-uniform brightness. Even if as mamy as possible CCFLs are connected, the brightness that can be acquired within the range of LCD's size is still non-uniform, especially for large size LCDs.

2. The CCFL has a shorter life. The brightness starts to fade for a use of about 4000-6000 hours and it is not easy to make a replacement, resulting in a largely reduced lifespan.

3. The CCFL has inadequate color saturation. It has a color temperature at about 4800 K, so that only a gamut of about 80% given in the NTSC (National Television System Committee) standard can be reached and, especially for red light, the performance is even worse. Thus, it is impossible to meet the requirement for high-specification color. For example, color imperfections can be clearly found in the situation of measurement with instruments or in the environment of a specific color performance.

4. The CCFL leads to higher power consumption in use; moreover, the noxious substance “mercury” would be involved in manufacturing, certainly resulting in harm to the environment, so the Kyoto Protocol agreed on the inhibition of use on 1 Jul. 2006. Therefore, to adopt other sources of backlight becomes an inevitable tendency in the development of the LCD.

The current technique commonly adopted in the industry lies in the employment of LEDs as the source of backlight. LEDs have been applied to small size LCD screens of, for example, handsets or PDAs (personal digital assistance) for some time. Recently the brightness of the LED was promoted greatly since the technology is promoted. In addition, the LED is light and solid and has long life and fast response time, so that it has become the select for many large size LCDs.

In general, LEDs are disposed as the source of backlight for an LCD in a way where varying number of LEDs are mounted on one side or both sides of the LCD so as to have light projected from the source onto the LCD for displaying the image thereon. However, typically light from LEDs is not scattered uniformly, but is focused in a small range and makes a particularly bright area on the LCD that has been subjected to the light projection. Yet, in the surroundings of the bright area notable brightness fading can be found and color can not be exhibited uniformly.

Besides, in any LCD apparatus mentioned above, overall instead of individual replacement of the illumination apparatus for backlight would be necessary when only a part thereof is damaged, thus making a very high cost. Moreover, not only the inevitable elimination of a single device leads to a waste of resource, but also the LCD wastes would cause a burden on the environmental protection.

In view of this, the present inventor(s) thought about a solution promptly. The present inventor(s) found out a way of light projection from the back of an LCD, wherein the light spotted from the source is refracted by 90° by a tapered prism, allowing the whole brightness and color presented uniformly. Further, the problems with respect to thermal breakdown and brightness fading in high power LCDs are eliminated with a specific mechanism of heat dissipation; simple maintenance is made possible for a design with independent modules. Through the research and experimentation, the present tapered prism illumination apparatus for LCD backlight is accomplished successfully as the outcome of the development.

### SUMMARY OF THE INVENTION

It is a primary object of the present invention to provide a tapered prism illumination apparatus for LCD backlight that uses high power LEDs as the source of light and allows the light from the source projected onto the tapered prism to be refracted with an appropriate angle to the surroundings of a reflector and then reflected onto a guide-light plate, so that the light from the source can be reflected to the LCD for colors of high brightness and high saturation presented thereon.

It is another object of the present invention to provide a tapered prism illumination apparatus for LCD backlight that provides a specific mechanism of heat dissipation for manufacturing backlight illumination modules according to a unique specification, thereby decreasing the probability of breakdown due to heat and promoting the yield and brightness for large size LCDs.

It is a further object of the present invention to provide a tapered prism illumination apparatus for LCD backlight, wherein the LEDs consist of minimolds and, as a result, when a single device is damaged, the module thereof can be replaced directly so that maintenance of large size LCDs is simple and feasible.

A tapered prism illumination apparatus for LCD backlight capable of fulfilling the purpose described above comprises an LCD, a plurality of LEDs, and a heat dissipation base. The plurality of LEDs is mounted in the back of the LCD, for generating and projecting light onto the LCD, and consists of high power LEDs capable of generating adequate light, wherein each of the LEDs includes a light emitting point that is packaged exteriorly with a transparent covering body and, on the light emitting path of the LED, a tapered prism is disposed. In the periphery of the LED a thermally conducting substrate is disposed, while the heat dissipation base is mounted in the rear of the LEDs and has reflecting faces, which are inclined planes, in the periphery of each of the LEDs. When light is emitted from the light emitting point, it can be projected onto the tapered prism, by which it is bent by an appropriate angle, and then projected via the reflecting faces onto a guide-light plate and a diffuser so as to uniformly spread on the LCD. The heat generated by the high power LEDs is conducted by the thermally conducting substrate to the heat dissipation base and, thus, the stability of the product can be kept.

### BRIEF DESCRIPTION OF THE DRAWINGS

The drawings disclose an illustrative embodiment of the present invention, which serves to exemplify the various advantages and objects hereof, and are as follows:

FIG. 1 is a 3-dim diagram of the tapered prism illumination apparatus for LCD backlight of the present invention;

FIG. 2 is a sectional view of the tapered prism illumination apparatus for LCD backlight in FIG. 1; and

FIG. 3 is a diagram showing the principle of action of the tapered prism illumination apparatus for LCD backlight in FIG. 1.

### DETAILED DESCRIPTION OF THE EMBODIMENTS

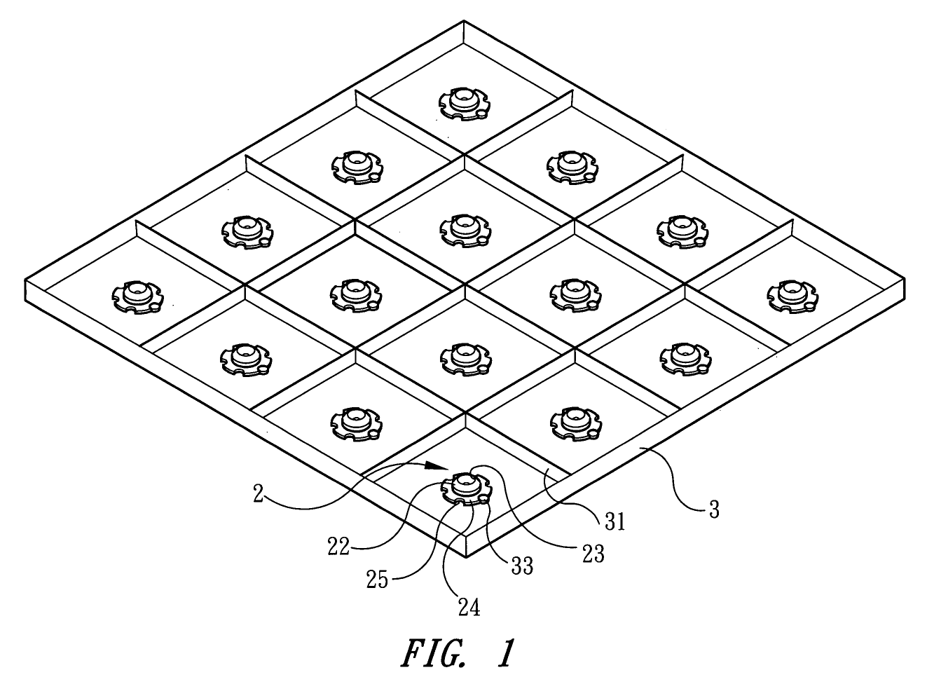

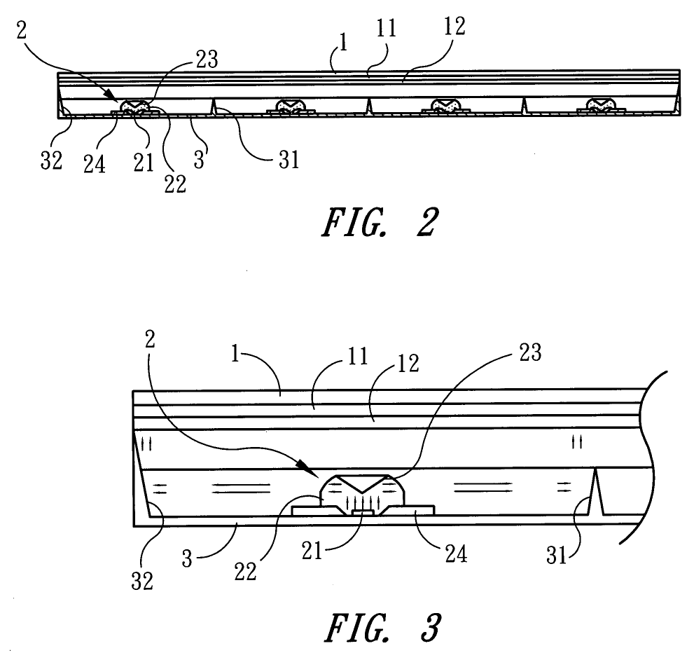

Referring to FIG. 1-3, the present invention provides a tapered prism illumination apparatus for LCD backlight, the apparatus comprising an LCD 1, a plurality of LEDs 2, and a heat dissipation base 3. The LCD 1 is used for producing an image, with a diffuser 11 and a guide-light plate 12 disposed in the back thereof, wherein the diffuser 11 is used for receiving the light from the source and performing a uniform distribution to prevent the light from focusing at one point, while the guide-light plate 12 is used for further scattering the light uniformly to make the image on the LCD 1 have even brightness and saturated color.

The plurality of LEDs 2 is mounted in the back of the LCD 1, for generating and projecting light onto the LCD 1, and consists of high power LEDs capable of generating adequate light. Each of the plurality of LEDs 2 includes a light emitting point 21 that is packaged exteriorly with a transparent covering body 22 and, on the light emitting path of the LED 2, a tapered prism 23 is disposed. When light is emitted from the light emitting point 21, it can be projected onto the tapered prism 23, by which it is bent by an appropriate angle, and then projected via the reflecting faces 31, 32 described below onto the LCD 1. In the periphery of the LED 2 a thermally conducting substrate 24 is disposed, which is a superconducting substrate made with a nanofabrication process, conducting the heat generated by the high power LEDs to a heat dissipation base 3 described below so as for the stability of the product to be kept.

The heat dissipation base 3 is mounted in the rear of the LEDs 2, for installing the LEDs 2 and a related circuit (not shown), wherein the reflecting faces 31, 32 thereof, which are inclined planes, are disposed in the periphery of each of the LEDs 2 so as to receive the light from the tapered prism 23 and to project the light onto the LCD 1 as the light has been bent.

Because each of the plurality of LEDs 2 is made with modular design, it is quite convenient for the present invention to manufacture and maintain. The LED 2 that has a breakdown can be replaced individually, with no need for the whole illumination apparatus for backlight.

With the structure described above, the operation of the present invention starts with the emission of light from the light emitting point 21. This light is projected through a path onto the tapered prism 23, by which it is bent by an appropriate angle, and then projected onto the reflecting faces 31, 32, by which it is bent and projected onto the LCD 1. Since the light has been scattered and uniformly projected onto the LCD 1 after multiple times of bending, it can be prevented from having disadvantageous nonuniform brightness such as being focused at one point on the LCD 1 and its lifespan would be prolonged. Besides, the present invention adopts the high power LEDs 2, whose heat can be conducted via the thermally conducting substrate 24 to the heat dissipation base 3. With the area distribution with respect to the heat dissipation base 3 and with materials such as copper, aluminum and iron that have efficient heat dissipation and low cost, the heat can be appropriately spread so that the endurance of the product is promoted.

The reflecting face 31 on the inner side of the foregoing LCD 1 is slightly lower than the reflecting face 32 in the periphery of the LCD 1. It is the purpose that the light from each of the plurality of the LED 2 can have an extended range to the periphery of the LED 2 for further diffusion of the light and can overlap the light from the neighboring LEDs 2 to make the light on the LCD more uniform.

Moreover, the modular design of the present invention facilitates the production of the related product. The present invention has further a positioning point 33 disposed on the heat dissipation base 3, for mounting the LED 2 easily. The present embodiment involves disposing a plurality of indentations 25 on the thermally conducting substrate 24, allowing the LED 2 and the thermally conducting substrate 24 to be positioned on the heat dissipation base 3 quickly for a rapid production.

Many changes and modifications in the above-described embodiment of the invention can, of course, be carried out without departing from the scope thereof. Accordingly, to promote the progress in science and the useful arts, the invention is disclosed and is intentionally limited only by the scope of the appended claims.

What is claimed is:

1. A tapered prism illumination apparatus for LCD backlight, comprising:
an LCD;
a plurality of LEDs, mounted in the back of the LCD, wherein each of the LEDs includes a light emitting point that is packaged exteriorly with a transparent covering body and, on the light emitting path of the LED, a tapered prism is disposed, and in the periphery of the base of the LED, a thermally conducting substrate is disposed; and
a heat dissipation base, mounted in the rear of the LEDs, for installing the LEDs and a related circuit, wherein in the periphery of each of the LEDs, reflecting faces of the heat dissipation base are disposed,
wherein the light emitted from the light emitting point is bent by the tapered prism to be projected onto the reflecting faces in the periphery and, then, bent by the reflecting faces to a guide-light plate and a diffuser, so that the light is uniformly presented on the LCD.

2. The tapered prism illumination apparatus for LCD backlight of claim 1, wherein the plurality of LEDs consists of high power LEDs.

3. The tapered prism illumination apparatus for LCD backlight of claim 1, wherein the tapered prism has an angle that causes the light emitted from the light emitting point to be bent by an appropriate angle.

4. The tapered prism illumination apparatus for LCD backlight of claim 1, wherein the reflecting faces are inclined planes.

5. The tapered prism illumination apparatus for LCD backlight of claim 1, wherein the reflecting face on the inner side of the LCD is slightly lower than the reflecting face in the periphery of the LCD, so that the light emitted from the LED diffuses further.

6. The tapered prism illumination apparatus for LCD backlight of claim 1, wherein a positioning point is disposed on the heat dissipation base, to facilitate locking the LED securely.

7. The tapered prism illumination apparatus for LCD backlight of claim 1, wherein a guide-light plate and a diffuser are disposed on the back side of the LCD, so that the light projected by the LED is uniformly projected via the guide-light plate and the diffuser onto the LCD.
